(19) United States
(12) Patent Application Publication
(10) Pub. No.: US 2026/0351049 A1
(43) Pub. Date: Nov. 5, 2026

(54) HISTOGRAM-BASED ACTION DETECTION

(71) Applicant: CARNEGIE MELLON UNIVERSITY, Pittsburgh, PA (US)

(72) Inventors: MARIOS SAVVIDES, Pittsburgh, PA (US); KAI HU, Pittsburgh, PA (US)

(73) Assignee: CARNEGIE MELLON UNIVERSITY, Pittsburgh, PA (US)

(21) Appl. No.: 19/099,939

(22) PCT Filed: Oct. 24, 2023
(86) PCT No.: PCT/US2023/035759

§ 371 Date: Jan. 30, 2025

Related U.S. Application Data
(60) Provisional application No. 63/418,798, filed on Oct. 24, 2022.

(51) Int. Cl. G06V 40/20; G06T 5/40; G06T 7/246; G06T 7/73; G06V 10/62; G06V 10/764

(52) U.S. Cl. CPC G06V 40/23; G06T 5/40; G06T 7/246; G06T 7/73; G06V 10/62; G06V 10/764; G06T 2207/20044; G06T 2207/30196

(57) ABSTRACT

Disclosed herein is a method for skeleton-based action recognition using handcrafted features. The input of the model is keypoint data of one or more skeletons from the frames of a video clip. Several histogram features are used to describe the spatial and temporal patterns of the corresponding body. These features are concatenated and sent to a linear classifier to predict the category of the actions.

### RELATED APPLICATIONS

This application is a national phase filing under 35 U.S.C. § 371 claiming the benefit of and priority to International Patent Application No. PCT/US23/35759, filed Oct. 24, 2023, entitle “HISTOGRAM-BASED ACTION DETECTION”, which claims the benefit of U.S. Provisional Patent Application No. 63/418,798, filed Oct. 24, 2022, the contents of which are incorporated herein in its entirety their entireties.

### BACKGROUND OF THE INVENTION

Skeleton-based action recognition is a computer vision task that involves recognizing human actions from 3D skeletal keypoint data captured, for example, from sequential frames of a video clip. A variety of sensors can be used for the capture of the video sequence, for example, standard video cameras, Microsoft Kinect devices, Intel RealSense devices and other wearable devices.

The skeletal keypoint data may be extracted from the frames of a video by a trained machine learning model. FIG. 1A shows one possible exemplary scheme for identifying the various body parts by number. For example, one scheme identifies keypoints representing the following body parts: nose, left eye, right eye, left ear, right ear, left shoulder, right shoulder, left elbow, right elbow, left wrist, right wrist, left hip, right hip, left knee, right knee, left ankle and right ankle. Other, more or less detailed schemes are equally valid and could be used with the disclosed methods. FIG. 1B shows an example of the keypoint data that might be extracted from a frame of a video clip.

The input to the action classification model will typically be in the form of a file containing the location of each keypoint with respect to a coordinate system defined in the context of a video frame. The input file may also contain other information, for example, the number of recorded frames in the video, the number of observed skeletons appearing in the current frame, the number of identified joints and the orientation of each joint. Other information may also be present in the file. In various embodiments, a separate file may be used for each frame of the video, or the data for all frames of the video may be present in a single file.

There are many prior art methods and models available for the detection, recognition and classification of actions based on keypoint data. State of the art methods for action recognition take as input the RGB frames of the video and use deep neural networks to classify the action. As a result, these models incur a heavy computational cost and are not suitable for real-time deployment on, for example, edge devices having limited computing capability.

### SUMMARY OF THE INVENTION

Disclosed herein is a method and model for skeleton-based action recognition using handcrafted features. The input of the model is keypoint data of one or more skeletal representations of bodies depicted in the frames of a video clip. Several histogram features are used to describe the spatial and temporal patterns of the corresponding body. These features are concatenated and sent to a linear classifier to predict the category of the actions.

The model disclosed herein provides the advantage of being lightweight and providing a fast inference time. The performance gap between the disclosed model and the state of the art method is acceptable. For example, on the UCF10 dataset, the best performance is 87% for state-of-the-art skeleton methods, while the model disclosed herein can achieve 85% accuracy but much more quickly (i.e., one the order of 100 to 1000 times quicker than traditional neural networks). This makes the disclosed model ideal for deployment on edge devices having limited computing resources.

### BRIEF DESCRIPTION OF THE DRAWINGS

FIG. 1 shows the tracking of the joints of a skeletal representation of a body through multiple frames of a video, providing a temporal component to the analysis of the depicted action.

FIG. 2 is a flowchart representing the steps of the disclosed method.

### DETAILED DESCRIPTION

Disclosed herein is a model that takes as input a set of novel features, namely histograms of keypoints representing the information of skeletal actions. After deriving the histogram-based features, the features are input to a single layer linear classifier that makes the action predictions. The disclosed method can be up to 1,000 times faster than neural networks. For example, on the NVIDIA Jetson Xavier device, the disclosed model takes no more than 2 ms to make predictions on a 5 second video dip. Most importantly, the performance of the disclosed model in terms of accuracy matches the performance of the state of the art models.

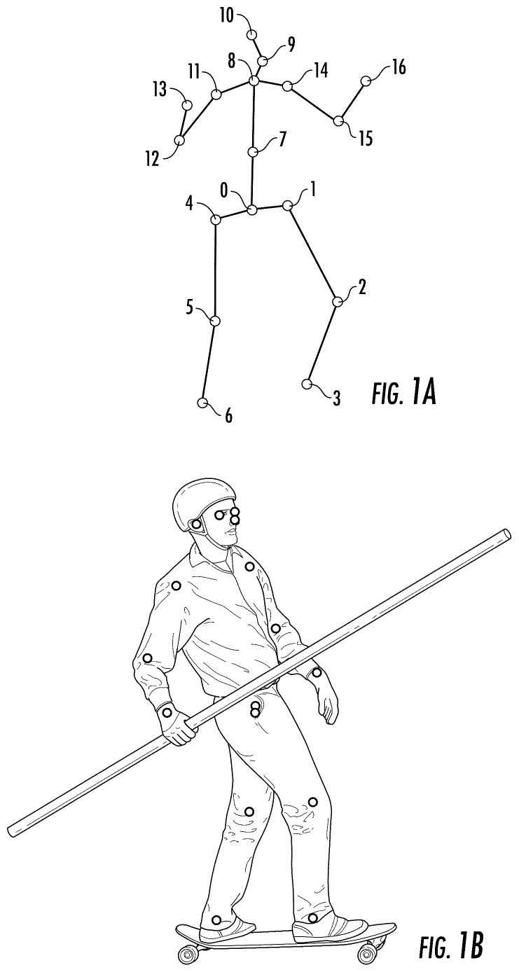

Consider a video clip of T frames, having at most N different persons depicted. The input of the disclosed model is a 4-D tensor of size N×T×P×2, where P is the number of keypoints in the keypoint scheme being used. For example, for the keypoint annotation scheme shown in FIG. 1A, P=17 (wherein the keypoints are numbered 0-16). The last dimension, “2”, represents the x and y coordinates of the keypoints in the frame. Specifically, let X be the 4-dimensional tensor input and X[n, t, p] a 1-dimensional array of two numbers, denoting the p^{th} keypoint of the n^{th} person in the t^{th} frame.

The relative position of two different keypoints in the same frame are used to represent the spatial information of the action. There are P keypoints, thus we have

$$\frac{P ( P - 1 )}{2}$$

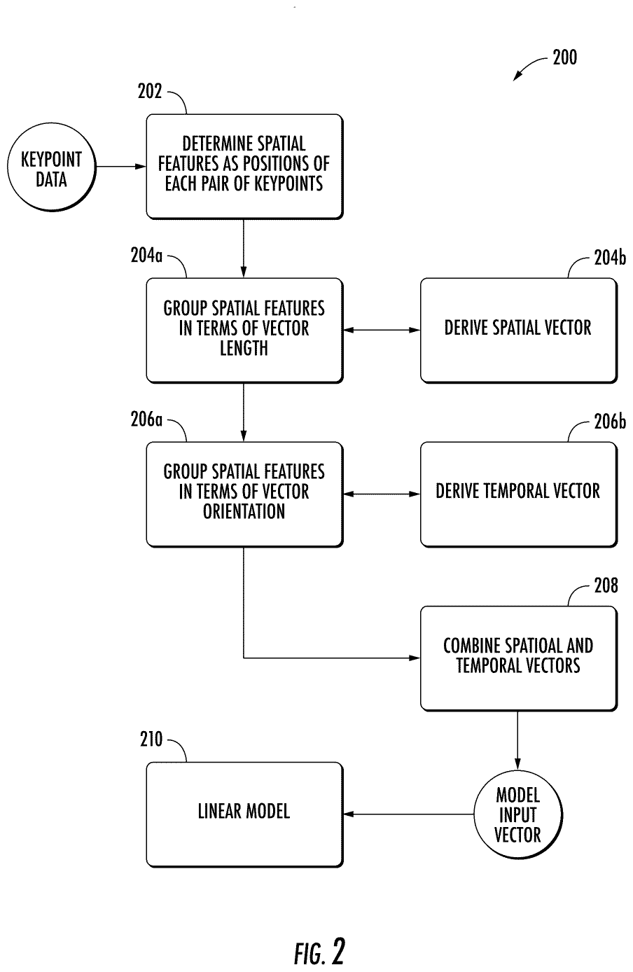

pairings of keypoints representing spatial features. Note that the keypoints representing a single body are only paired with other keypoints from that same body. Comparing the relative keypoints from two different bodies has no meaning as far as determining the actions of a single body. The pairings are derived in step 202 in FIG. 2. For every i ranging from 1 to P and j ranging from i+1 to P, the relative position features of keypoint i and keypoint j are:

S_{i,j}={X[n, t, i]−X[n, t, j]|∀n∈[1, N], t∈[1, T]} (1)

There are NT vectors in the set S_{i,j}. When the video clip is long or many persons show up in the video clip, the number of features are large. To reduce the number of features, the features are grouped into B bins and a histogram of these features is derived.

The features are first grouped in terms of the vector length, as shown in step 204a. Suppose the maximum length of the vectors in S_{i,j} is L. In this case, B groups are created where the b^{th} group contains the vectors whose length is between

$$\frac{b - 1}{B} L$$

and

$$\frac{b}{B} L .$$

Then, a histogram of size B can be derived. The b^{th} number in the histogram is the ratio of vectors falling into the b^{th} bin.

The features are next grouped in terms of the vector orientation at step 206a. B groups are created, where the b^{th} group contains the vectors whose orientation to the horizontal is between

$$\frac{b - 1}{B} \times 360$$

and

$$\frac{b}{B} \times 360.$$

This also results in a histogram of size B.

For each of the

$$\frac{P ( P - 1 )}{2}$$

pairings (spatial features), two histograms of size B result. Thus, the total size of the spatial feature for each body sis BP(P−1).

The movement of one keypoint from one frame to δ frames later is used to represent the temporal information. For every i ranging from 1 to P and the hyperparameter δ, the temporal features of keypoint i are:

T_{i,j}={X[n, t, i]−X[n, t+δ, j]|∀n∈[1, N], t∈[1, T−δ]} (2)

The hyperparameter δ describes the motion speed and multi views of the temporal information with different speeds are needed. Intuitively, 8 choices of the hyperparameter have been selected:
δ∈ [1, 2, 4, 8, T/8, T/16, T/24, T/32]

As T is the number of frames in the video, the first 4 choices for δ describe the motion information that is invariant of the playing speed, while the last 4 choices for δ describe the motion information that is invariant of the video length. As would be realized, the hyperparameter δ could represent any set of frames within the video clip.

Similar to the spatial features, the vectors are also grouped by vector length and orientation. The total size of the resulting temporal feature is then 8P×2B.

The input to the classifier that classifies the action is a vector of a size depending on the chosen B (i.e., the number of bins in the histograms). The feature representing the spatial information is derived in step 204b and the feature representing the temporal information is derived in step 206b. A higher number of bins provides higher accuracy while a lower number of bins increases speed. B=9 provides a good trade off between acturacy and speed. At B=9, the feature size is 2448 for both spatial and temporal information. These two features derived in 204b and 206b are concatenated in step 208, resulting in a 4896-dimensional vector, which is used as the final handcrafted feature (note that the size of the final vector will vary based on the selection of the value for B). The final vector is then input to trained model 210.

The trained model 210 is preferably a linear classifier, but model 210 can be any architecture of trained machine learning model. In preferred embodiments, trained model 210 is a 2-layer MLP (multi-layer perceptron) trained by solving a logistic regression on a training dataset.

As would be realized by those of skill in the art, the novelty of the invention lies in the preparation and derivation of the histogram-based feature vector. The specific derivation is provided as an exemplary embodiment only and the invention is not meant to be limited thereby. Modifications and variations are intended to be within the scope of the invention, which is given by the following claims:

1. A method comprising:
receiving a set of coordinates representing locations of skeletal keypoints in multiple frames of a video clip showing actions of a one or more bodies represented by the skeletal keypoints;
extracting, from the set of coordinates, spatial vectors representing relative positions of each pair of keypoints with in each frame;
extracting, from the set of coordinates, temporal vectors representing relative positions of each keypoint over multiple frames;
grouping the spatial vectors into a first set of a predetermined number of bins based on lengths of the spatial vectors and into a second set of the predetermined number of bins based on orientations of the spatial vectors;
grouping the temporal vectors into a third set of the predetermined number of bins based on lengths of the temporal vectors and into a fourth set of the predetermined number of bins based on orientations of the temporal vectors;
deriving an input vector representing comprising a spatial feature and a temporal feature representing the number of spatial and temporal vectors falling into each bin in each set of bins respectively; and
inputting the input vectors into an action classifier and receiving a classification of an action of the one or more bodies in the video clip.

2. The method of claim 1 further comprising:
obtaining a video clip; and
putting the video clip to a pose estimation machine learning model; and
receiving the set of coordinates representing locations of skeletal keypoints from the pose estimation machine learning model.

3. The method of claim 1 wherein the action classifier is a trained machine learning model trained by solving a logistic regression on a training dataset.

4. The method of claim 3 wherein the action classifier is a 2-layer perceptron.

5. The method of claim 1 wherein the input vector is a 4-dimensional tensor of size N×T×P×2;
wherein N is the number of bodies depicted in the video clip;
wherein T is the number of frames in the video clip;
wherein P is the number of keypoints per body; and
wherein 2 represents the number of coordinates describing the location of each keypoint.

6. The method of claim 1 wherein the spatial vectors represent the relative positions of the keypoints with respect only to other keypoints within the body containing the respective keypoints, resulting in a set of spatial vectors for each body shown in the video clip.

7. The method of claim 1 wherein in grouping the spatial vectors into the first and second sets of the predetermined number of bins create histograms of the spatial vectors.

8. The method of claim 1 wherein in grouping the temporal vectors into the third and fourth sets of the predetermined number of bins create histograms of the temporal vectors.

9. The method of claim 1 wherein a size of the spatial feature is BP(P−1);
wherein B is the predetermined number of bins; and
wherein P is the number of keypoints per body.

10. The method of claim 1 wherein the temporal feature captures motion speed information by extracting vectors over a sampling of frames within the video clip.

11. The method of claim 10 wherein the sampling of frames is given by a hyperparameter representing the frames between which the relative positions of each pair of keypoint are extracted.

12. The method of claim 11 wherein the hyperparameter is of the form:
δ∈ [1, 2, 4, 8, T/8, T/16, T/24, T/32]
wherein T is the number of frames in the video clip.

13. The method of claim 12 wherein the sampling of frames represents motion information that is invariant to both playing speed of the video and the video length.

14. The method of claim 1 wherein a size of the temporal feature is 8P×2B;
wherein B is the predetermined number of bins; and
wherein P is the number of keypoints per body.

15. The method of claim 1 wherein a higher number of bins provides greater accuracy, while a lower number of bins provides faster speed.
